(19) United States
(12) Patent Application Publication
(10) Pub. No.: US 2010/0040719 A1
(43) Pub. Date: Feb. 18, 2010

(54) MOLD TEMPERATURE CONTROLLING DEVICE

(75) Inventors: HOU-YAO LIN, Tu-Cheng (TW); SHENG-JUNG YU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/535,776

(22) Filed: Aug. 5, 2009

(30) Foreign Application Priority Data
Aug. 14, 2008 (CN) 200810303764.2

(51) Int. Cl. B29C 33/02

(52) U.S. Cl. 425/144

(57) ABSTRACT

A mold temperature controlling device includes a main body. The main body defines a recess in a surface thereof and through holes therein. The recess is configured to receive a mold core. The through holes are positioned around the recess and configured to allow mold temperature adjusting fluid to flow through.

### BACKGROUND

1. Technical Field

The disclosure relates to a mold temperature controlling device.

2. Description of Related Art

In a molding process, controlling mold temperature is a crucial step to ensure quality of a finished product. A typical method of controlling mold temperature is to apply fluid to a mold core to heat or cool the mold core. In such a method, hot or cool fluid flows through passages in the mold core to adjust temperature of the mold. Molding different products requires different passage structures. However, a typical mold core does not have a flexible passage structure, which makes it not suitable to mold different products.

Therefore, a new mold temperature controlling device is desired to overcome the above-described shortcoming.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a perspective view of one embodiment of a mold temperature controlling device.

FIG. 2 is a cross-sectional view of the mold temperature controlling device of FIG. 1, taken along line II-II.

FIG. 3 is a cross-sectional view of the mold temperature controlling device of FIG. 1, taken along line III-III.

FIGS. 4 and 5 are perspective views of the mold temperature controlling device of FIG. 1, in use.

### DETAILED DESCRIPTION OF THE EMBODIMENTS

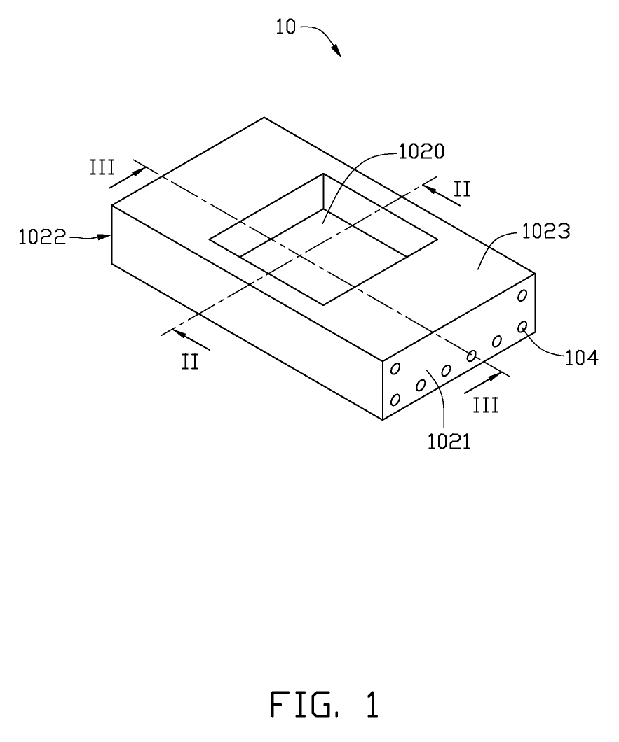

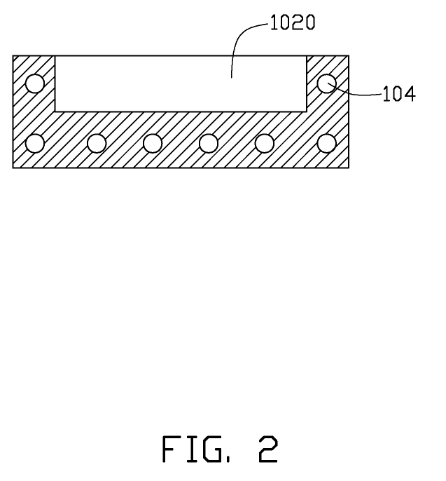

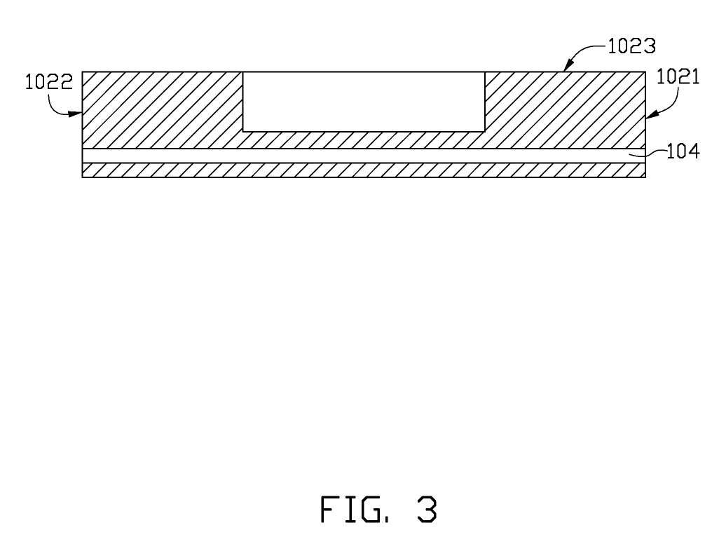

Referring to FIGS. 1-3, one embodiment of a mold temperature controlling device includes a substantially rectangular-shaped main body 10. The main body 10 has a first and second sidewalls 1021, 1022 and a top portion 1023. The first and second sidewalls 1021, 1022 are positioned at two opposite ends of the main body 10. The top portion 1023 is connected between the first and second sidewalls 1021, 1022.

A recess 1020 is defined in the top portion 1023. A plurality of through holes 104 is defined in the main body 10. Each through hole 104 perpendicularly extends from the first sidewall 1021 to the second sidewall 1022. In the illustrated embodiment, the recess 1020 is substantially rectangular-shaped. The main body 10 defines eight through holes 104 therein. The through holes 104 are parallel to each other and substantially evenly surround the recess 1020.

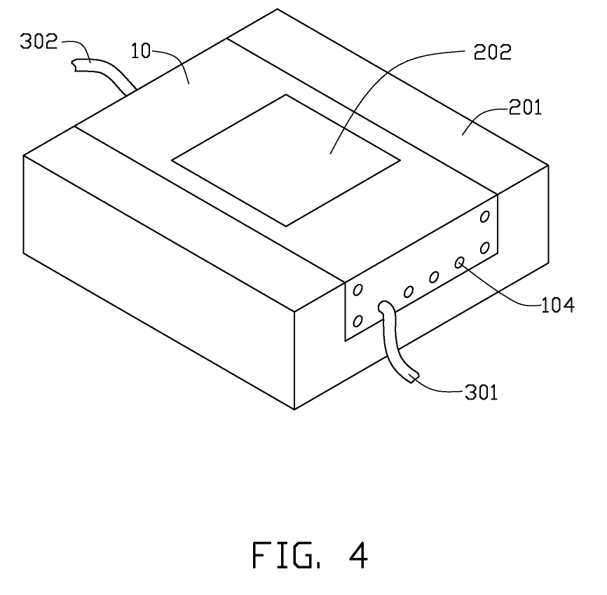

Referring to FIG. 4, in molding a product, a mold core 202 is received in the recess 1020. The main body 10 is placed in a holder 201 and partially surrounded by the holder 201. A first pipe 301 is connected to an end of a through hole 104, and a second pipe 303 is connected to another end of the corresponding through hole 104. Fluid flows into the through hole 104 from the first pipe 301, and flows out the corresponding through hole 104 from the second pipe 302. As a result, the fluid can cool or heat the mold core 202. The fluid may be water or oil, in one example.

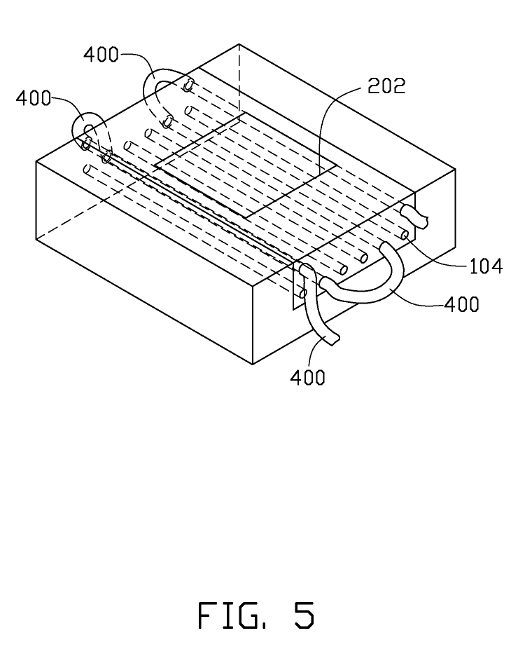

Referring to FIG. 5, in molding another product, four out of eight through holes communicate with each other by five pipes 400. Fluid flows through the four through holes 104 and evenly surrounds the mold core 202, so as to effectively cool or heat the mold core 202.

The through holes 104 can be flexibly selected to facilitate control of temperature of the mold, which makes the main body 10 suitable for being used to mold different products.

It is believed that the present embodiments and their advantages will be understood from the foregoing description, and it will be apparent that various changes may be made thereto without departing from the spirit and scope of the embodiments or sacrificing all of its material advantage.

What is claimed is:

1. A mold temperature controlling device, comprising:
a main body, the main body defining a recess configured to receive a mold core in a surface thereof and a plurality of through holes therein, wherein the through holes are positioned around the recess and configured to allow mold temperature adjusting fluid to flow through.

2. The mold temperature controlling device of claim 1, wherein the main body comprises a first sidewall, a second sidewall and a top portion, the first and second sidewalls are positioned at two opposite ends of the main body, the top portion is connected between the first and second sidewalls, the recess is defined in the top portion, and the through holes extend from the first sidewall to the second sidewall.

3. The mold temperature controlling device of claim 2, wherein the through holes are parallel to each other and perpendicularly extend from the first sidewall to the second sidewall.

4. The mold temperature controlling device of claim 3, wherein the main body defines eight through holes therein.

5. The mold temperature controlling device of claim 1, wherein the through holes surround the recess.

6. The mold temperature controlling device of claim 1, wherein the recess is substantially rectangular-shaped.

7. The mold temperature controlling device of claim 1, wherein the main body is substantially rectangular-shaped.

8. A body for a mold temperature controlling device, comprising:
a first and second sidewalls positioned at two opposite ends thereof; and
a top portion connected between the first and second sidewalls;
wherein a recess is defined in the top portion, and a plurality of through holes is defined in the body and extends from the first sidewall to the second sidewall.

9. The body of claim 8, wherein the through holes are parallel to each other and perpendicularly extend from the first sidewall to the second sidewall.

10. The body of claim 9, wherein the through holes evenly surround the recess.

11. The body of claim 10, wherein eight through holes are defined in the body.

12. The body of claim 8, wherein the recess is substantially rectangular-shaped.

13. The body of claim 8, wherein the body is substantially rectangular-shaped.
